(19) United States
(12) Patent Application Publication
(10) Pub. No.: US 2024/0253898 A1
(43) Pub. Date: Aug. 1, 2024

(54) DETACHABLE SANITARY HANDLE FOR FOREARM LIFTING OF REFUSE/RECYCLE BIN LIDS

(71) Applicant: MTG CAPITAL LLC, Atlanta, GA (US)

(72) Inventors: Michael T. Goldberg, Athens, GA (US); Thardsageni Ganesalingam, Markham (CA); Parm Ghai, Burlington (CA); Tiago Berbat Curio, Toronto (CA); Febryo Johan Ficano, Toronto (CA); Maya Edie-Maxsom, Toronto (CA); Preetjot Kaur Buall, Vaughan (CA); Christopher Nicholas Kardos, Vaughn (CA)

(21) Appl. No.: 18/102,195

(22) Filed: Jan. 27, 2023

(51) Int. Cl. B65F 1/16

(52) U.S. Cl. CPC B65F 1/1623

(57) ABSTRACT

A device for lifting a lid of a refuse or recycling bin provides a sanitary mechanism for accessing the inside of the refuse or recycling bin to deposit items, without interfering with emptying of the refuse or recycling bin by sanitation/recycling trucks. The device includes a body having a handle portion and an attachment portion. The handle portion is adapted for lifting by a user's forearm, and the attachment portion extends away from the handle portion. The device also includes a securing mechanism for attaching the body to the lid of the refuse or recycling bin. The securing mechanism may be a spring clip for securing the body to the refuse or recycling bin and affixed to the attachment portion of the body and may optionally be attached to a separate plate that is detachable from the attachment portion of the body.

### BACKGROUND

### 1. Field of Disclosure

The field of representative embodiments of this disclosure relates generally to removable handles for manipulating items, and more particularly, to a forearm-manipulable detachable handle for opening and closing refuse and/or recycling bins.

### 2. Description of the Related Art

Refuse and recycling bins are handled not only by residents and employees of business establishments, but may also be handled by waste collection and recycling collection service personnel. Due to the multiple contacts that may be made with the lid of a refuse or recycling bin, it is desirable to reduce the possibility of bacterial and viral community circulation promoted by such contact. Contact with the lid of a refuse or recycling bin may also be made by pedestrians, animals, or insects.

Any modification of a refuse or recycling bin must not impede operation by human operators or interfere with collection truck operations. Further, any modification should be made in such a manner that bacterial and viral spread is actually reduced, so that a modification does not end up spreading contamination.

Therefore, it would be desirable to provide a device that reduces spread of bacterial and viral via refuse or recycling bin contact without otherwise interfering with the normal operation and handling of the refuse or recycling bins.

### SUMMARY

Reducing spread of bacterial and viral via refuse or recycling bin contact, while not interfering with normal operations is achieved in a device and its method of use.

The device is a device for lifting a lid of a refuse or recycling bin. The device includes a body having a handle portion and an attachment portion. The handle portion is adapted for lifting by a user's forearm, and the attachment portion extends away from the handle portion. The device also includes a securing mechanism for attaching the body to the lid of the refuse or recycling bin. The securing mechanism may be a spring clip for securing the body to the refuse or recycling bin and affixed to the attachment portion of the body. The securing mechanism may include a first plate detachably secured to the attachment portion of the body, and the attachment portion of the body may include a second plate for abutting the first plate when the securing mechanism is attached to attachment portion of the body, so that the body may be detached from the refuse or recycling bin while the spring clip and the plate are retained on the lid.

The summary above is provided for brief explanation and does not restrict the scope of the Claims. The description below sets forth example embodiments according to this disclosure. Further embodiments and implementations will be apparent to those having ordinary skill in the art. Persons having ordinary skill in the art will recognize that various equivalent techniques may be applied in lieu of, or in conjunction with, the embodiments discussed below, and all such equivalents are encompassed by the present disclosure.

### BRIEF DESCRIPTION OF THE DRAWINGS

FIG. 1 is a perspective view showing an example installation of an example device 10 to a lid 7 of a refuse/recycling bin 5, in accordance with an embodiment of the disclosure.

FIG. 2 is a perspective view showing an example installation of another example device 10A to lid 7 of refuse/recycling bin 5, in accordance with another embodiment of the disclosure.

FIG. 3 is a lower-right perspective view of example device 10A of FIG. 2, in accordance with an embodiment of the disclosure.

FIG. 4 is an upper-right perspective view of example device 10A of FIG. 2, in accordance with an embodiment of the disclosure.

FIG. 5 is side view of example device 10A of FIG. 2, in accordance with an embodiment of the disclosure.

FIG. 6 is dimensioned side view of example device 10A of FIG. 2, in accordance with an embodiment of the disclosure.

FIG. 7 is an exploded upper-right perspective view of example device 10A of FIG. 2, in accordance with an embodiment of the disclosure.

FIG. 8 is an exploded side view of example device 10A of FIG. 2, in accordance with an embodiment of the disclosure.

FIG. 9 is an upper-right perspective view of example device 10 of FIG. 1, in accordance with an embodiment of the disclosure.

FIG. 10 is a lower-right perspective view of example device 10 of FIG. 1, in accordance with an embodiment of the disclosure.

FIG. 11 is side view of example device 10 of FIG. 1, in accordance with an embodiment of the disclosure.

FIG. 12 is a lower-right perspective view showing design features of example device 10 of FIG. 1, in accordance with an embodiment of the disclosure.

FIG. 13 is an upper-right perspective view showing design features of example device 10 of FIG. 1, in accordance with an embodiment of the disclosure.

### DETAILED DESCRIPTION OF ILLUSTRATIVE EMBODIMENT

The present disclosure reveals devices and their associated methods of operation and manufacture that provide sanitary manipulation of refuse and recycling bin lids. The devices are for lifting lids of a refuse or recycling bin, and include a handle portion and an attachment portion. The handle portion is adapted for lifting by a user's forearm, and the attachment portion extends away from the handle portion. The device also includes a securing mechanism for attaching the body to the lid of the refuse or recycling bin.

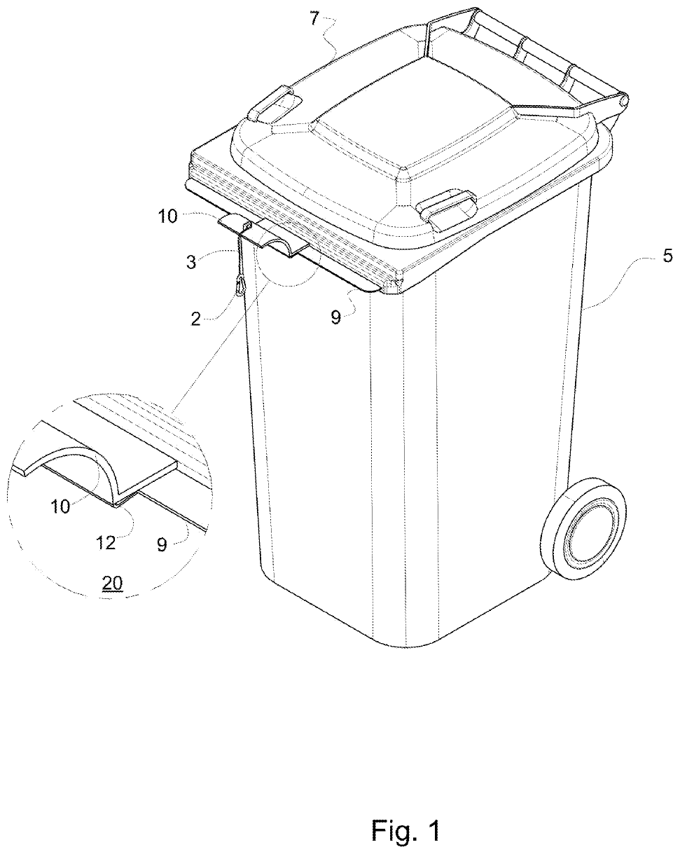

Referring now to FIG. 1, a perspective view of an example installation of an example device 10 to a lid 7 of a refuse/recycling bin 5 is shown, in accordance with an embodiment of the disclosure. Example device 10 is attached to an edge 9 of lid 7 and the attachment may be by a clip, as described in further detail below with respect to certain embodiments of the disclosure that are readily detachable, or by an adhesive such as double-sided tape or foam adhesive, or by screws or bolts fastened through example device 10 to attach example device 10 to lid 7. A cord 3 terminating in a carabiner 2 may be secured to example device 10, to provide for storage, such as attaching carabiner 2 to another location bin 5, or to attach to a belt loop or ring of a user, so that the user is not required to touch device 10 directly. Detail call-out 20 shows details of attachment of example device 10 to edge 9 of lid 7 via a metal spring-clip 12 that exert sufficient pressure on edge 9 that example device 10 is not easily detached from lid 7, while making it possible to remove device 10 by grabbing the body of example device 10 or by pulling on cord 3.

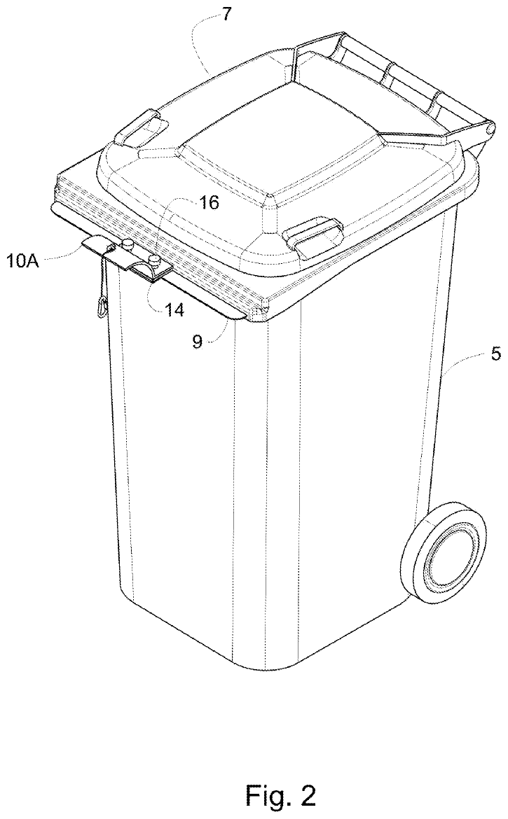

Referring now to FIG. 2, a perspective view showing an example installation of another example device 10A to lid 7 of refuse/recycling bin 5, in accordance with another embodiment of the disclosure. A pair of knobs 16 attach the body of device 10A to a securing plate 14 that may remain mounted on lid 7 after device 10A is used, for example, to remove device 10A when bin 5 is placed at a curb for pick-up.

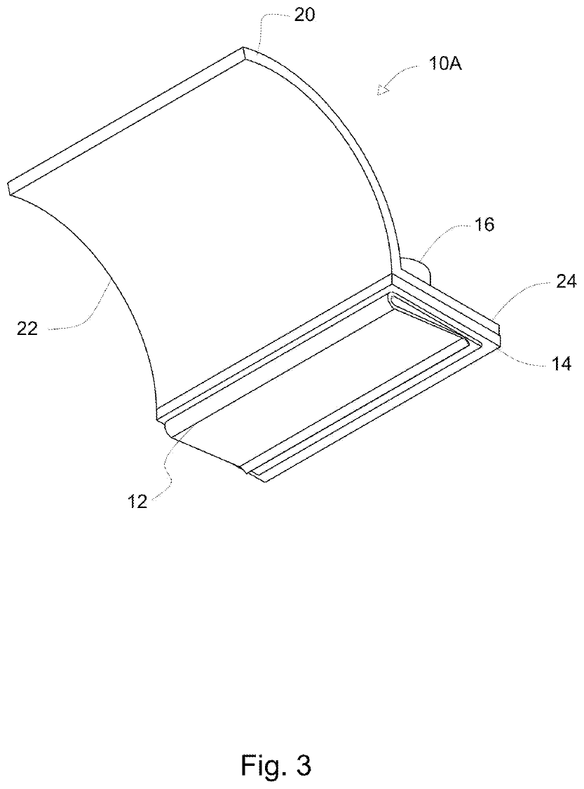

Referring now to FIG. 3, a lower-right perspective view of example device 10A of FIG. 2 is shown, in accordance with an embodiment of the disclosure. Spring clip 12 is attached to mounting plate 14, for example, by a durable adhesive such as epoxy, by a flexible and weather-resistance adhesive such as silicone caulk, or by molding a portion of spring clip 12 within the body of mounting plate 14, which, along with the body of example device 10A (and example device 10 as described above) may be formed by injection molding or printed via 3D printing process, from a durable material such as nylon, polycarbonate, or similar materials. Alternatively, the components of example device 10 and example device 10A may be cast, machined, or molded from a metal or a composite material. Mounting plate 14 is secured to an attachment portion 24 of example device 10A, which is in the form of a rectangular plate having a profile matching mounting plate 14, by removable knobs 16. A handle portion 22 of a body 20 of device 10A that may extend contiguously from attachment portion 24, is adapted for lifting by a user's forearm by providing a suitably curved lower face profile, so that contact with the hands need not be made during lifting of a bin lid, but so that handle portion 22 will not easily slip off from a user's forearm.

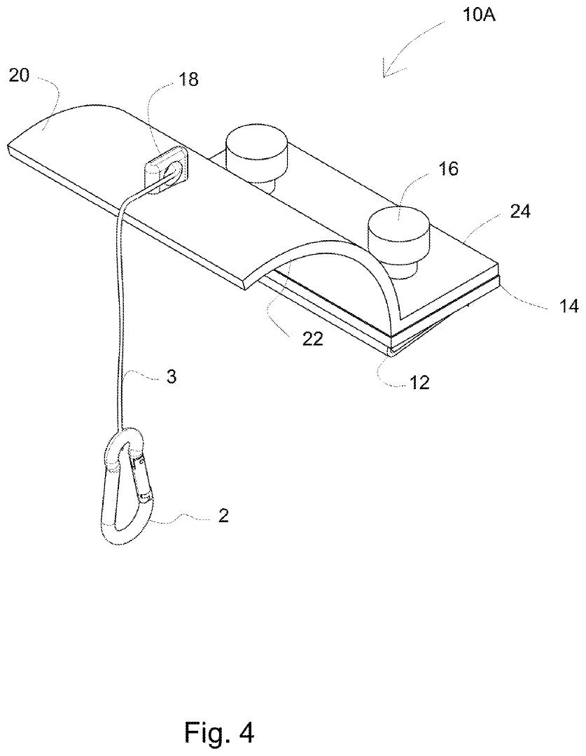

Referring now to FIG. 4, an upper-right perspective view of example device 10A of FIG. 2 is shown, in accordance with an embodiment of the disclosure. A post 18, with a hole provided therethrough, is formed on a top side of handle portion 12 receives an end of cord 3, which is fastened to post 18 by a knot, and carabiner 2 is attached to the other end of cord 3. Knobs 16 secure mounting plate 14 to attachment portion 24.

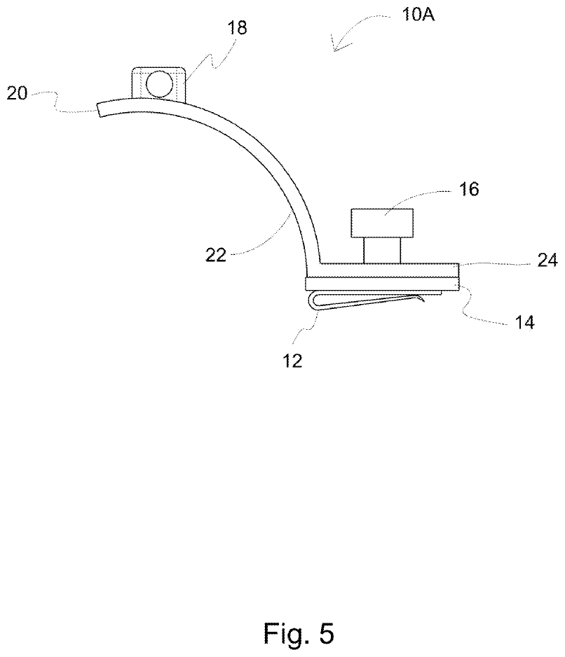

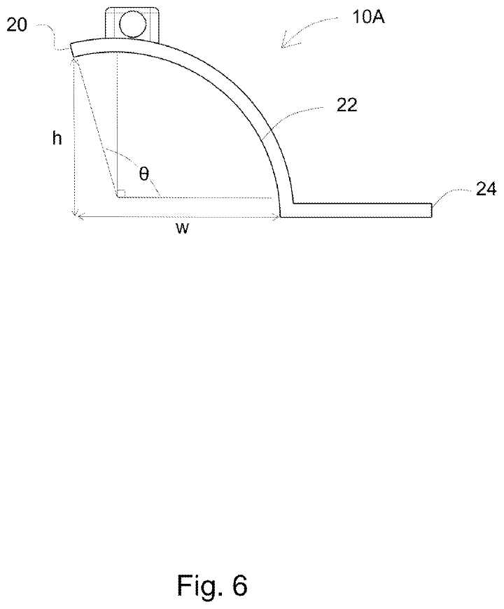

Referring now to FIG. 5, a side view of example device 10A of FIG. 2 is shown, in accordance with an embodiment of the disclosure. The shape of the curved lower surface of handle portion 22 is visible and has an elliptical shape with a vertical minor axis and a horizontal major axis when the bin lid is closed and example device 10A is attached to a bin. Referring additionally to FIG. 6, specific example dimensions of example device 10A are illustrated, in a dimensioned side view. In the depicted example, handle portion 22 extends with a width w of 8 centimeters and a height h of six centimeters along an ellipsoidal or quasi-ellipsoidal arc having a portended angle θ that extends past 90 degrees, but is less than 180 degrees, e.g., an arc of 108 degrees as shown.

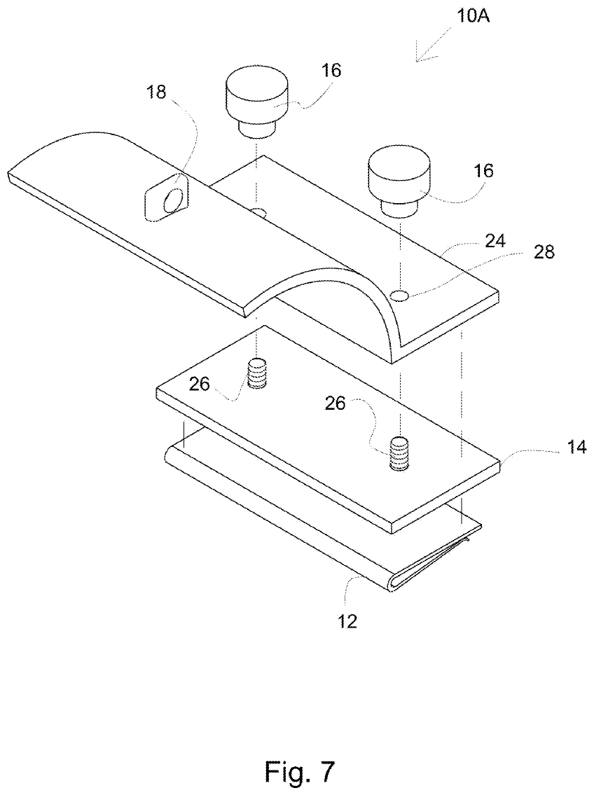

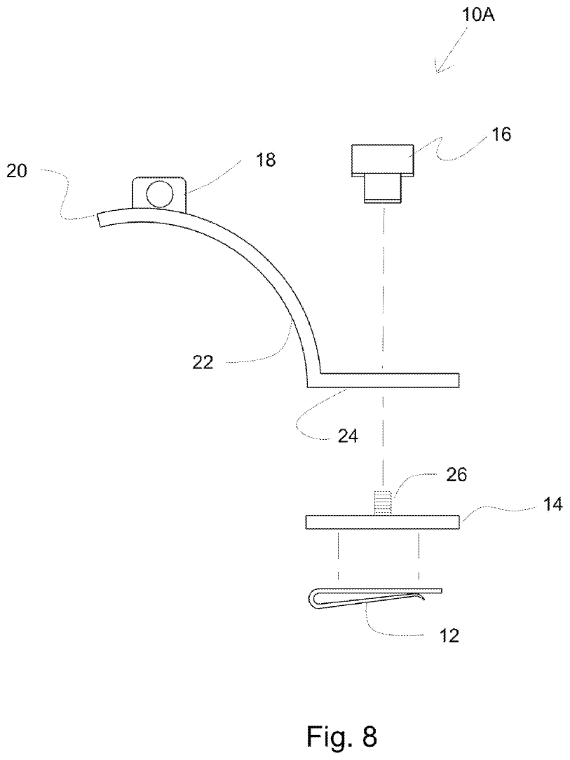

Referring now to FIG. 7, an exploded upper-right perspective view of example device 10A of FIG. 2 is shown, in accordance with an embodiment of the disclosure. A pair of threaded posts 26 extends upward from mounting plate through holes 28 provided through the plate provided as attachment portion 24 of device body 20. Knobs 16 have a female thread matching the male thread pattern of threaded posts 26, but other thread arrangements are contemplated by the embodiments of the disclosure, including hollow female threaded posts with knobs having externally threaded projections. The top side of spring clip 12 is visible and is the surface to which the above-described bonding agents would be applied for adhesive attachment of spring clip 12. FIG. 8 shows an exploded side view of example device 10A of FIG. 2, in accordance with an embodiment of the disclosure, showing further details of the profile of spring clip 12, threaded posts 26 and knobs 16.

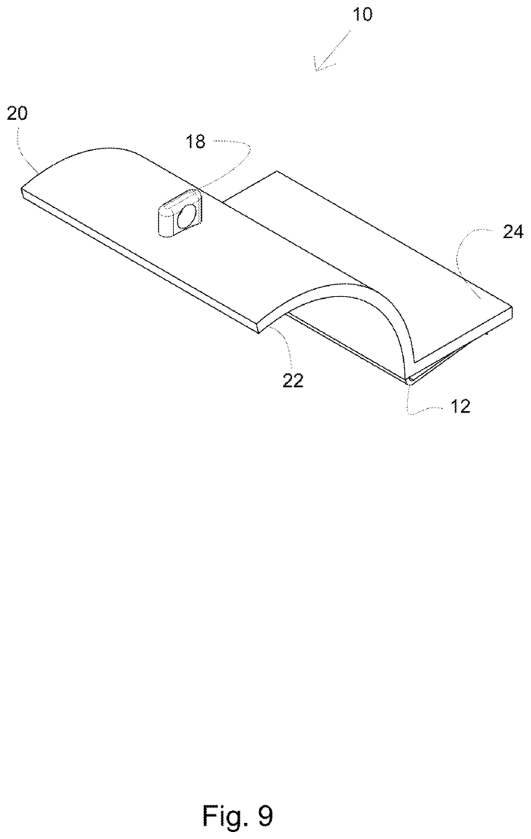

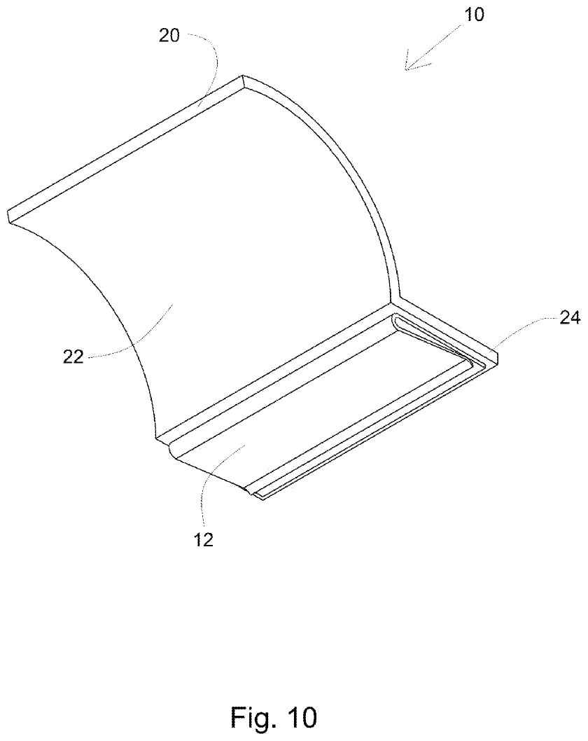

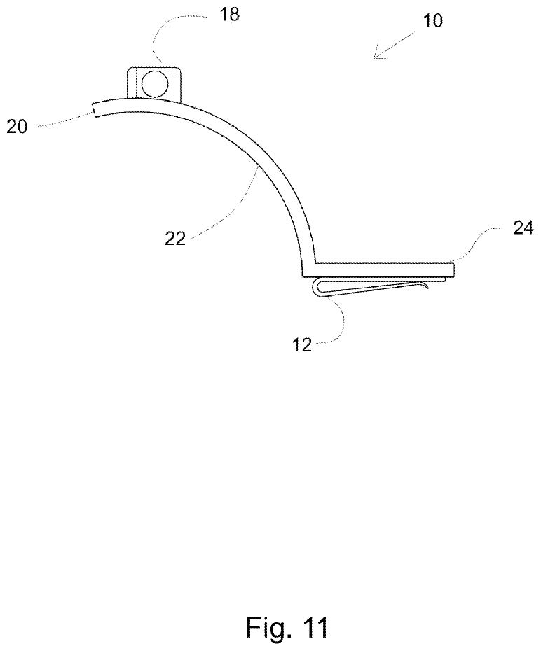

Referring now to FIG. 9, an upper-right perspective view of example device 10 of FIG. 1 is shown, in accordance with an embodiment of the disclosure. FIG. 10 is a lower-right perspective view of example device 10 of FIG. 1, in accordance with an embodiment of the disclosure. Example device 10 provides an example of a unitary device, as described above, with spring clip 12 directly mounted to attachment portion 24 of example device 10. FIG. 11 is a side view of example device 10 of FIG. 1, in accordance with an embodiment of the disclosure, and in which the shape of the handle portion 22 matches that of example device 10 of FIG. 1, as described above with reference to FIG. 6.

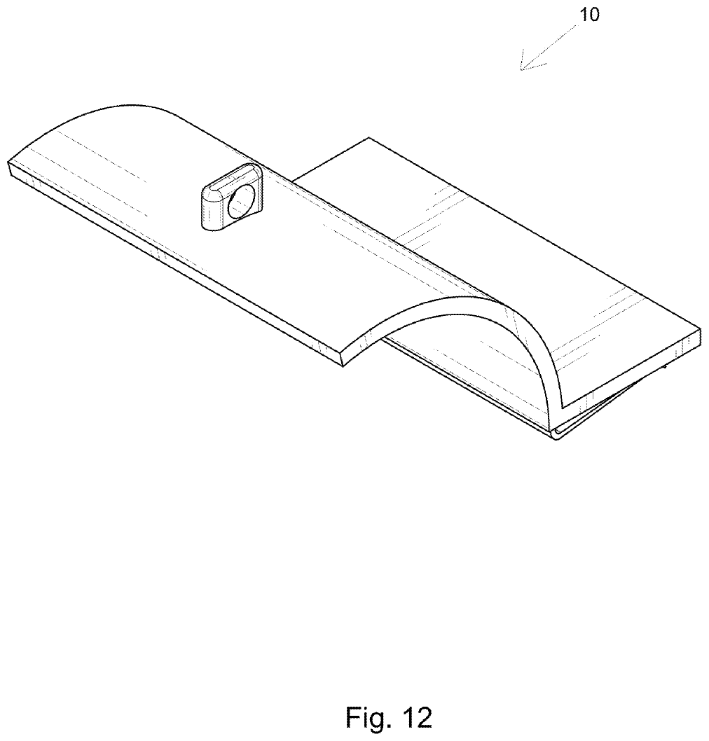

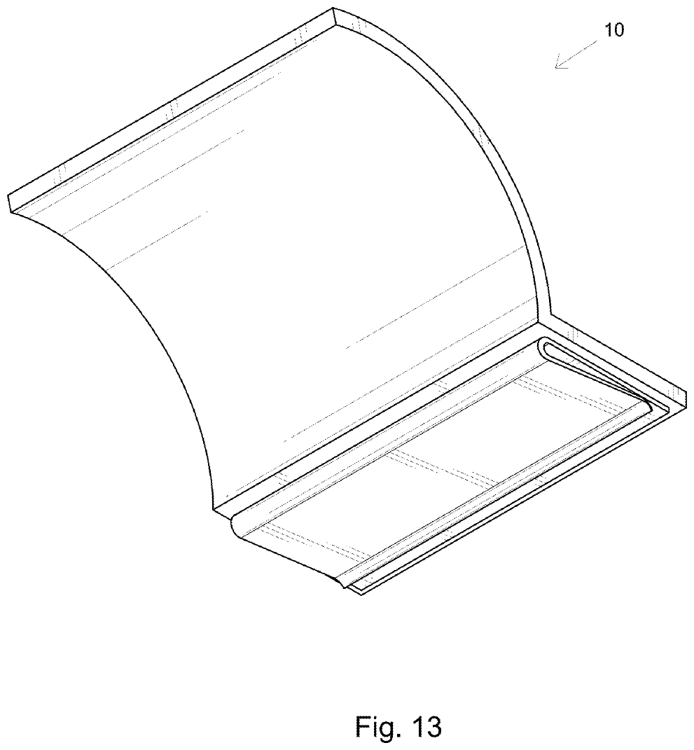

FIG. 12 is a lower-right perspective view showing design features of example device 10 of FIG. 1, in accordance with an embodiment of the disclosure. FIG. 13 is an upper-right perspective view showing design features of example device 10 of FIG. 1, in accordance with an embodiment of the disclosure.

In summary, this disclosure shows and describes example devices for lifting a lid of a refuse or recycling bin. The devices may include a body having a handle portion and an attachment portion. The handle portion may be adapted for lifting by a user's forearm, and the attachment portion may extend away from the handle portion. The device may also include a securing mechanism for attaching the body to the lid of the refuse or recycling bin.

In some example embodiments, the securing mechanism is a spring clip for securing the body to the refuse or recycling bin and affixed to the attachment portion of the body. In some example embodiments the securing mechanism may further include a first plate detachably secured to the attachment portion of the body, and the attachment portion of the body may include a second plate for abutting the first plate when the securing mechanism is attached to attachment portion of the body, so that the body may be detached from the refuse or recycling bin while the spring clip and the plate are retained on the lid. In some example embodiments, the first plate may include a pair of threaded studs extending perpendicular to a top face of the first plate, and the second plate may define a pair of holes adapted for accepting the pair of threaded studs therethrough. The device may further include a pair of threaded knobs having threads complementary to the threaded studs, so that the body may be detachably secured to the securing mechanism.

In some example embodiments, the spring clip may be bonded onto the attachment portion of the body. In some example embodiments, the handle portion of the body may describe a semi-elliptical cross-sectional profile in a plane extending from a distal end of the handle portion of the body to the attachment portion. In some example embodiments, an arc portended by the semi-elliptical profile is greater than 90 degrees and less than 180 degrees. In some example embodiments, a major axis of the semi-elliptical profile may be 8 centimeters and the minor axis of the semi-elliptical profile may be 6 centimeters. In some example embodiments, the body may be fabricated from an anti-bacterial material or coated with an anti-bacterial material. In some example embodiments, the device may further include a cord and a carabiner attached to the cord at a first end, and the body may further include a post formed on a top surface of the body and having a passage formed therethrough for securing the second end of the cord with a knot.

While the disclosure has shown and described particular embodiments of the techniques disclosed herein, it will be understood by those skilled in the art that the foregoing and other changes in form, and details may be made therein without departing from the spirit and scope of the disclosure. For example, the mounting techniques shown above may be applied to other types of covered enclosures.

What is claimed is:

1. A device for lifting a lid of a refuse or recycling bin, the device comprising:
a body having a handle portion and an attachment portion, wherein the handle portion is adapted for lifting by a user's forearm, and wherein the attachment portion extends away from the handle portion; and
a securing mechanism for attaching the body to the lid of the refuse or recycling bin.

2. The device of claim 1, wherein the securing mechanism is a spring clip for securing the body to the refuse or recycling bin and affixed to the attachment portion of the body.

3. The device of claim 2, wherein the securing mechanism further comprises a first plate detachably secured to the attachment portion of the body, and wherein the attachment portion of the body comprises a second plate for abutting the first plate when the securing mechanism is attached to attachment portion of the body, whereby the body may be detached from the refuse or recycling bin while the spring clip and the plate are retained on the lid.

4. The device of claim 3, wherein the first plate comprises a pair of threaded studs extending perpendicular to a top face of the first plate, wherein the second plate defines a pair of holes positioned for accepting the pair of threaded studs therethrough, and wherein the device further comprises a pair of threaded knobs having threads complementary to the threaded studs, whereby the body is detachably securable to the securing mechanism.

5. The device of claim 2, wherein the spring clip is bonded onto the attachment portion of the body.

6. The device of claim 1, wherein the handle portion of the body describes a semi-elliptical cross-sectional profile in a plane extending from a distal end of the handle portion of the body to the attachment portion.

7. The device of claim 5, wherein an arc portended by the semi-elliptical profile is greater than 90 degrees and less than 180 degrees.

8. The device of claim 7, wherein a major axis of the semi-elliptical profile is 8 centimeters and the minor axis of the semi-elliptical profile is 6 centimeters.

9. The device of claim 1, wherein the body is fabricated from an anti-bacterial material or coated with an anti-bacterial material.

10. The device of claim 1, wherein the device further comprises a cord and a carabiner attached to the cord at a first end therefor, and wherein the body further comprises a post formed on a top surface of the body and having a passage formed therethrough for securing the second end of the cord with a knot.

11. A method of lifting a lid of a refuse or recycling bin, the method comprising:
attaching a device to the body to the lid of the refuse or recycling bin by a securing mechanism of the device, wherein the device includes the securing mechanism and a body having a handle portion and an attachment portion that extends away from the handle portion; and
lifting the lid of the refuse or recycling bin by a user's forearm.

12. The method of claim 11, wherein the attaching secures a spring clip of the securing mechanism to the refuse or recycling bin.

13. The method of claim 12, wherein the attaching further detachably secures a first plate of the securing mechanism to the attachment portion of the body so that a second plate of the attachment portion of the body abuts the first plate, and wherein the method further comprises detaching the body from the refuse or recycling bin while the spring clip and the plate are retained on the lid.

14. The method of claim 13, wherein the detachably securing of the first plate to the attachment portion comprises securing a pair of threaded knobs to a pair of threaded studs extending perpendicular from a top face of the first plate and extending through a pair of holes provided through the second plate.

15. The method of claim 12, further comprising bonding the spring clip onto the attachment portion of the body.

16. The method of claim 11, wherein the handle portion of the body describes a semi-elliptical cross-sectional profile in a plane extending from a distal end of the handle portion of the body to the attachment portion.

17. The method of claim 16, wherein an arc portended by the semi-elliptical profile is greater than 90 degrees and less than 180 degrees.

18. The method of claim 17, wherein a major axis of the semi-elliptical profile is 8 centimeters and the minor axis of the semi-elliptical profile is 6 centimeters.

19. The method of claim 11, further comprising fabricating the body from or coating the body with an anti-bacterial material.

20. The method of claim 11, wherein the body further comprises a post formed on a top surface of the body and having a passage formed therethrough for securing a cord with a knot, and wherein the method further comprises attaching a first end of the cord to the post, and attaching a carabiner to a second end of the cord.
